(19) United States
(12) Patent Application Publication
(10) Pub. No.: US 2007/0203898 A1
(43) Pub. Date: Aug. 30, 2007

(54) Search methods and systems

(76) Inventor: Jonathan Lurie Carmona, Irvine, CA (US)

Correspondence Address: Robert Popa, Esq.;c/o LADAS & PARRY, Suite 2100, 5670 Wilshire Boulevard, Los Angeles, CA, 90036-5679, US

(21) Appl. No.: 11/362,271

(22) Filed: Feb. 24, 2006

(51) Int. Cl. G06F 17/30

(52) U.S. Cl. 707/4

(57) ABSTRACT

Metadata is received over a network, a query is received over the network, and the metadata is searched to identify metadata that is relevant to the query.

### TECHNICAL FIELD

This disclosure relates to search methods and systems, and more particularly to computer implemented data search methods and systems on a network.

### BACKGROUND

The generation and availability of information has recently undergone an evolution fueled by ever-faster computers, more sophisticated software to operate these computers, and more extensive networks to connect the computers, as epitomized most pervasively by the global network of networks commonly known as the Internet. The networks and computers connected via the Internet exchange various types of data using various high-level protocols on top of the underlying TCP/IP (Transport Control Protocol/Internet Protocol), such as Simple Mail Transport Protocol (SMTP) and Post Office Protocol 3 (POP3) for electronic mail (e-mail), File Transfer Protocol (FTP) for file transfer, and Hypertext Transport Protocol (HTTP) for hypertext documents and their associated files.

There are currently billions of such hypertext documents (e.g., web pages) hyperlinked to other hypertext documents, forming the loosely-organized web-like structure known as the World Wide Web or, much more often, WWW or simply “the Web.” The Web contains a staggering amount of information that has led to a recent paradigm shift wherein information has changed from a valuable commodity in very limited supply to a diluted commodity available in an overabundance. There is no question that the value of timely, accurate information has never been higher, but the modern-day challenge has shifted from acquiring or developing valuable information to sifting it from the mass of irrelevant, stale, and/or erroneous information clogging the Web.

Perhaps the principal reason for the vast and ever-increasing number of hyperlinked documents on the Web is that there is no real control over who can add pages to the Web. The lack of structure as well as the sheer amount of data available on the Internet become increasingly difficult obstacles to surmount for those seeking particular information, who are forced to navigate through vast oceans of unrelated information in haphazard, random fashion. Such users increasingly turn to computerized “search engines” to find and sort through the large quantity of information available.

Many such search engines are currently available, including the ubiquitous Yahoo! and Google, each of which relies on its own search systems and processes. Regardless of the proliferation of such search engines, they all operate in a very similar fashion insofar as the user is concerned. Thus, typically a user inputs a query and a search process returns one or more “links” identifying web pages that the search engine has identified as being related to the query. The links returned may number anywhere from hundreds to tens of thousands, and typically can range from highly relevant to completely irrelevant to what the user is actually looking for. The relevance of the results of any such search depends on many factors, including the query terms and query structure as input by the user, the underlying methods and processes of the search engine, and the database or index of web pages searched by the engine.

All search engines currently available on the Web essentially rely upon the same approach to indexing the pages available on the Web—they “crawl” the web at predetermined intervals to identify new pages that have become available since the last update, then search through the new pages to index key words that appear in each page. Thus, any time a search is conducted by a user, the results of that search will only be as up to date as the last “Web crawl” performed by the search engine. With new pages being added to the Web by the thousands per minute, it is readily apparent that a major drawback of current search technology is that a user needs to repeatedly perform a search to keep the results up to date.

Another drawback of current search technology is that the user has little to no control over how the search is conducted and where, beyond selecting the search terms and, in some search engines, a few rudimentary options such as which top level domain to search, over which date range, etc. Furthermore, the user has no knowledge whatsoever as to the internal processes of each search engine, all of which differ from one another and which is why the same exact search query will never yield the same results on two different search engines.

Finally, besides allowing the end user little control over the search, current search engines allow essentially no control to the web page providers over how or when their web page is searched. The only method by which web page providers can possibly impact the way a search engine will assess their web page during any particular search is by the deliberate inclusion and/or exclusion of certain words in the page. This is a crude way of directing search engines towards or away from one's web page, and has fostered certain practices wherein unscrupulous web page providers “stuff” their web pages with popular search terms that in reality have absolutely no relation to the content of their web page in order to garner a high ranking on search engine searches and thus divert Internet traffic to their web page, where the unwitting user may be exposed to all sorts of advertising and other information unrelated to what the user is searching for. Obviously, this practice further dilutes the useful information available on the Web and complicates the job of those seeking such information.

What is currently needed are methods and systems for searching computerized networks such as the Internet for relevant information in a highly flexible and customizable manner, provides relevant results with a high degree of accuracy, and can preferably be continuously updated in an effortless, transparent manner to the end user. The embodiments of the present disclosure answer these and other needs.

### SUMMARY

In a first embodiment disclosed herein, a method comprises receiving metadata over a network, receiving a query over the network, and searching through the metadata to identify metadata that is relevant to the query.

In another embodiment disclosed herein, a computer-readable medium contains one or more instructions for execution by a computer to receive metadata over a network, receive a query over the network, and search through the metadata to identify metadata that is relevant to the query.

In a further embodiment disclosed herein, an apparatus is provided for receiving metadata over a network, receiving a query over the network, and searching through the metadata to identify metadata that is relevant to the query.

These and other features and advantages will become further apparent from the detailed description and accompanying figures that follow. In the figures and description, numerals indicate the various features, like numerals referring to like features throughout both the drawings and the description.

### BRIEF DESCRIPTION OF THE DRAWINGS

FIG. 1 is a diagram representation of a system operating according to the present disclosure; and

FIG. 2 is a flowchart depiction of a method of operating the system of FIG. 1.

### DETAILED DESCRIPTION

One of the fundamental concepts at the core of the methods and systems disclosed herein is that web page or content providers (hereinafter “providers”) choose how to describe their web page or content (hereinafter “content”) to the rest of the network (e.g. the Internet) by providing metadata describing their content to a centralized repository for such metadata. As is understood, metadata may take many forms and follow many schemes, any and all of which may be employed within the present disclosure. This is not merely a shift of the responsibility for updating the search engine index from the search engine to the content provider, because the provider now has the ability to dictate ab initio and with great precision the exact type of searches that will identify the provider's particular content.

By forwarding new content to a centralized repository, content providers now also bestow upon those searching the repository for information an extremely powerful new capability, namely receiving real-time continuous updates to their searches. Because the providers update the metadata in the repository whenever they update their content, the repository is always up-to-date and a search may be conducted automatically each and every time any new metadata is uploaded to the repository or updated. The new results of the search may then be forwarded to the searching party or they may be analyzed and various actions taken in accordance with the results of the analysis and preselected rules.

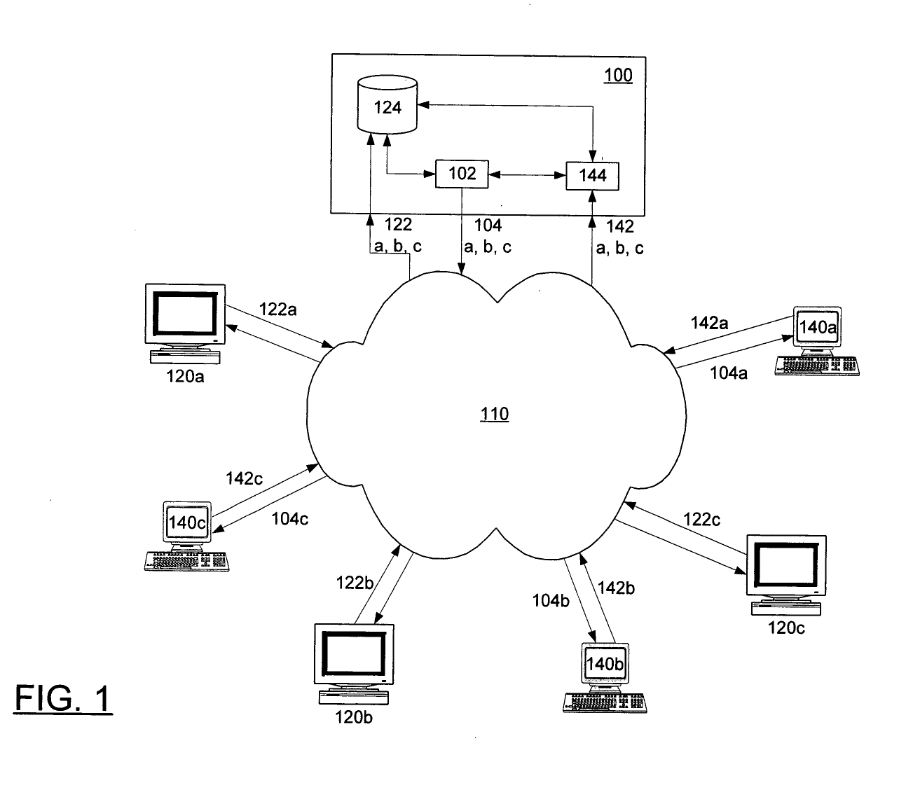

With particularity, FIG. 1 is a functional diagram depicting the various entities and their interaction in one novel search method according to the present disclosure. Although both content providers and searching parties are users of the metadata repository, for ease of reference the searching parties are referred to hereinafter as “customers.” Thus, with continued reference to FIG. 1, a novel search method as disclosed herein contemplates the use of a centralized metadata repository 100 that is accessible through a network such as the Internet 110. Various content providers 120a,b,c can access the repository 100 at any time to upload metadata 122a,b,c describing their respective content onto the repository or to update previously uploaded metadata. It is to be understood that the term “content providers” is intended to encompass any and all entities connected to the Internet and any and all information, goods and services (including virtual and real-world) that such entities may provide. It is also important to note that uploading of the metadata to the central repository is initiated by and under the control of the content providers, each of whom prepares the metadata and decides when to upload it to the repository.

The repository 100 thus amasses all received metadata 122a,b,c into a centrally accessible metadata store 124. With continued reference to FIG. 1, customers 140 a, b, c can also access the repository 100 at any time through the Internet to present queries 142a,b,c to the repository to search through the metadata store 124 for various content. The repository may include a search engine 144 that is programmed to search the metadata store 124 for each query 142a,b,c to identify any stored metadata 122 that is relevant to each respective query. Finally, the repository also may include a communications module 102 for responding 104 to each customer query 142, such as by forwarding to each customer the identity and/or contact information (including physical location and/or network address) of one or more content providers that have uploaded metadata relevant to the respective customer query, and/or forwarding the actual relevant metadata.

It must be understood that the form and content of the metadata 122, the form of the customer queries 142, the structure of the metadata store 124, and the processes executed by the search engine 144 to identify metadata relevant to the queries are all irrelevant to the present disclosure and all practicable forms, structures, and processes are contemplated for use within the scope of the present disclosure. Similarly, any manner for presenting, ordering, and/or ranking relevant metadata to the customers is also contemplated by the present disclosure. Furthermore, the interaction between customers and content providers may also be structured in any practicable manner, such as direct over the network, or through the repository 100, or any other path, all of which are contemplated for use within the scope of the present disclosure.

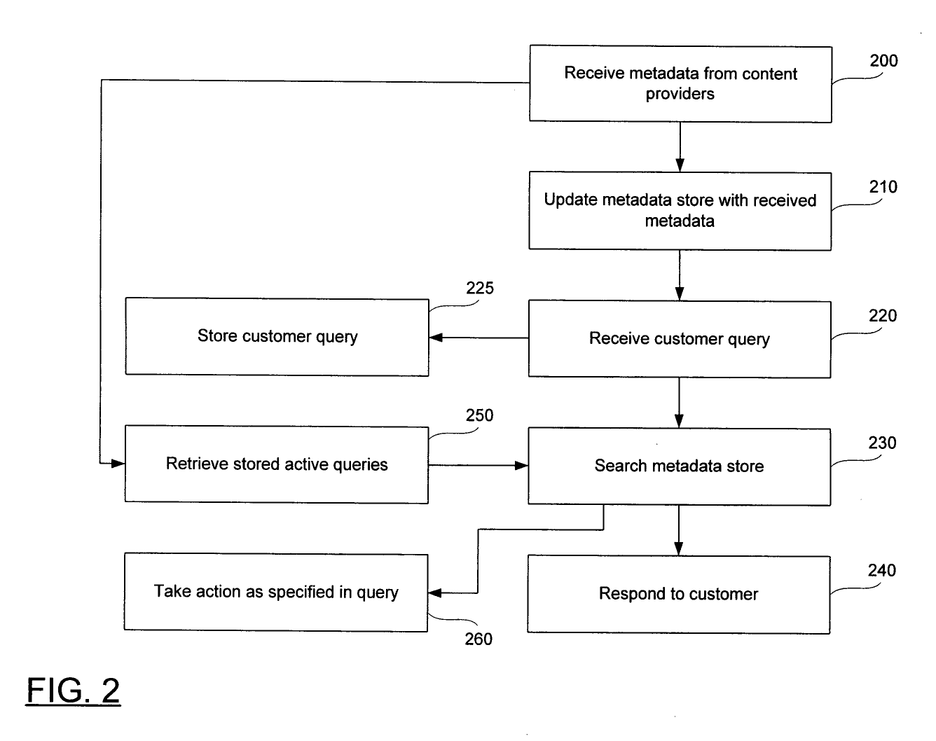

With reference now to FIG. 2, in one possible novel search method according to the present disclosure, a central repository such as central repository 100 of FIG. 1 receives 200 metadata from various content providers and updates 210 metadata store 124 with the received metadata, as previously described with respect to FIG. 1. When a query is received 220 from a customer, a search is performed 230 of the metadata in the metadata store to identify metadata that is relevant to the customer query. Following the metadata search, the repository may respond 240 to the customer as disclosed above.

As previously noted, a powerful feature of the presently disclosed method is that it allows the continuous, real-time updating of any query. Thus, optionally, the present method may further entail storing 225 a received customer query, such as for a predetermined period of time which may be selected by the customer and which may be indicated in the query itself. Thus, with continued reference to FIG. 2, after the metadata store has been updated 210, stored queries may be retrieved 250 and optionally verified that they are active (or optionally, the stored queries may be periodically verified and the expired queries discarded from storage), following which a search may be performed 230 for each active stored query and a response forwarded 240 to each respective customer. Stored queries may be searched every time the metadata store is updated or at periodic intervals selected in view of any combination of factors desirable.

A significant advantage of this method therefore is that a customer can ensure always having the latest information regarding a particular topic available with no effort or time expended by the customer; a query need only be uploaded to the repository once, and the repository can then automatically send the customer each quantum of new relevant information as such new relevant information becomes available. Furthermore, given that in the present method the content providers have complete control over the metadata that describes their content, the probability of an irrelevant content provider being identified in response to a customer's query is greatly minimized, and thus the customer can be assured that each new update forwarded by the repository is not just timely but also relevant.

The ability to receive continuous, timely updates to a query empowers the customer to use the present method to monitor any condition or event as long as it is reported or quantized by a content provider that is associated with the metadata repository and uploads metadata to the repository descriptive of such condition or event. As a result, a further benefit conferred by the present method includes the ability for the customer to specify action to be taken on behalf of the customer in response to specific conditions or events that the customer may monitor through a continuously active query. Such action or actions may also be specified in the query itself. Thus, following a search of the metadata store 124, the repository may further take action 260 as specified in the query and in light of relevant metadata identified in the search.

The list of possible uses for the present novel method is long and all such uses are encompassed within the scope of the present disclosure. A few such examples are discussed herein for purposes of illustration only, and the skilled persons perusing the present specification will understand how to apply the present methods and systems to any and all other practicable uses. Such uses may be purely commercial, such as a customer posting (uploading) a query on the repository for a particular item for sale in a particular price range. The instant a content provider (e.g. the ubiquitous eBay.com) uploads metadata to the repository indicating that such an item is available for sale, the repository may alert the customer, and/or may contact the content provider to obtain further details regarding the item then forward this additional information to the customer or decide that the item is not what the customer is looking for and take no further action, or conclude that this item is indeed the desired one and in the proper price range and then take further action such as order the item or place a bid with the content provider for the item on behalf of the customer. Such rules-based computer implementations are well known to the skilled reader and thus not further discussed herein.

A customer may also choose to monitor news through the present method, and thus monitor websites (content providers) that post information such as weather alerts, traffic information/alerts, terrorist alerts, the whereabouts of ex-felons (such as convicted pedophiles who are required to register with local law enforcement authorities) and whether any such person moves into the customer's neighborhood, etc. A customer may also monitor job postings, on the websites of placement agencies and/or on the websites of particular employers. A customer may monitor the financial markets either by tracking actual financial information and/or breaking stories on particular topics that may impact the customer's portfolio and/or business, and predefining actions such as contacting the customer's stock broker to buying/sell stocks. A customer may use the present method for aid in managing healthcare, such as by monitoring news regarding medicine the customer is taking and afflictions the customer suffers from, and predefining actions such as making a doctor appointment for the customer.

As is apparent, the present disclosure provides new and unique methods and systems for news dissemination and content distribution, wherein the customer query described above may be employed as a subscription—a highly focused, continuously updated subscription for the precise content of interest to the customer, and nothing beyond. Such subscriptions can also define actions such as delivery of the content from the provider to the customer through the repository or through a customer-specified channel (e.g. to an e-mail account), filtering of the content, etc.

The practical implementation of the present methods and systems can take many forms as should be apparent to the skilled person, all of which are contemplated within the scope of the present disclosure. The metadata repository may thus take the form of a web page accessible via the Internet by customers through a typical web browser, which can present the customer with a list of all content providers using the repository and assist the customer in building queries. The repository may provide other customer services, such as suggest specific content providers and/or specific content (data, goods, services) based upon the customer's queries. The repository may also track a customer's queries and optionally require certain personal information from each customer, thereby being able to build a profile of each customer that could then be used to deliver/suggest further content (including targeted advertisements) to the customer.

The implementation of the repository may advantageously leverage existing service-oriented architectures (SOA) and event-driven architectures (EDA), employing distributed technologies such as Microsoft® Web Services. The content provider end may be served by an ultra thin layer on top of the web to provide a platform for the content providers to develop applications that can upload their metadata to the repository, and interact with the repository and/or customers to receive requests for further information and/or to take action. Such applications can run on the content provider site to automatically upload and update metadata to the provider as the provider's content is changed and updated.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . ”

What is claimed is:

1. A method, comprising:
receiving metadata over a network;
receiving a query over the network; and
searching through the metadata to identify metadata that is relevant to the query.

2. The method of claim 1, wherein:
receiving the metadata comprises receiving the metadata over the network from providers; and
receiving the query comprises receiving the query over the network from a customer.

3. A method wherein providers of content select metadata descriptive of their respective content and initiate transfer of the metadata over a network, the method comprising:
receiving the metadata over the network from the providers;
receiving a query over the network from a customer; and
searching through the metadata to identify metadata that is relevant to the query.

4. The method of any one of claims 1-3, further comprising:
responding to the customer query by forwarding to the customer over the network the identity of one or more providers that provided metadata identified as relevant to the customer query.

5. The method of any one of claims 1-3, further comprising:
responding to the customer query by forwarding to the customer over the network metadata identified as relevant to the customer query.

6. The method of any one of claims 1-3, further comprising:
responding to the customer query by forwarding to the customer over the network one or more of metadata identified as relevant to the customer query and the identity of one or more providers that provided forwarded metadata.

7. The method of claim 6, wherein the identity of each provider that is forwarded to the customer is received from the respective provider.

8. The method of any one of claims 1-3, further comprising:
responding to the customer query by taking action on behalf of the customer.

9. The method of claim 8, wherein the action taken on behalf of the customer is defined by the customer.

10. The method of any one of claims 1-3, further comprising:
receiving additional metadata after receiving the customer query and searching through the metadata; and
searching through the additional metadata to identify additional metadata that is relevant to the customer query.

11. The method of claim 10, further comprising:
after identifying additional metadata that is relevant to the customer query, responding to the customer query by taking action on behalf of the customer.

12. The method of claim 11, wherein the action taken on behalf of the customer is defined by the customer.

13. The method of claim 10, further comprising:
after identifying additional metadata that is relevant to the customer query, responding to the customer query by forwarding to the customer over the network either one or both of the additional metadata identified as relevant to the customer query and the identity of the provider that provided each additional metadata identified as relevant to the customer query.

14. The method of any one of claims 1-3, wherein the metadata received from each provider describes any one or more of data, services, and/or goods available to the customer from the respective provider, data, services, and/or goods desired by the respective provider, and real-world events.

15. The method of any one of claims 1-3, further comprising:
receiving an update to the customer query from the customer after searching through the metadata; and
searching through the metadata to identify metadata that is relevant to the updated customer query.

16. The method of any one of claims 1-3, further comprising:
receiving a plurality of customer queries over the network;
searching through the metadata to identify metadata that is relevant to each of the plurality of received customer queries;
responding to each received customer query by forwarding to the respective customer over the network one or more of metadata identified as relevant to the query and the identity of one or more providers that provided relevant metadata;
receiving additional metadata after responding to the plurality of received customer queries; and
searching through the additional metadata to identify additional metadata that is relevant to each received customer query.

17. The method of claim 16, further comprising:
after identifying additional metadata that is relevant to one or more of the received customer queries, responding to one or more of the received customer queries by forwarding to each respective customer over the network either one or both of additional metadata identified as relevant to the particular customer query and the identity of one or more providers that provided relevant metadata.

18. The method of claim 16, further comprising:
after identifying additional metadata that is relevant to each received customer query, responding to one or more of the received customer queries by taking action on behalf of the respective customer.

19. The method of claim 16, further comprising:
repeatedly receiving additional metadata; and
searching each received additional metadata to identify metadata relevant to any of the received customer queries.

20. The method of claim 10, wherein received additional metadata is searched to identify metadata relevant to the customer query until a time period expires.

21. The method of claim 20, wherein the time period is specified by the customer.

22. The method of any one of claims 1-2, wherein receiving metadata is initiated by each respective metadata provider.

23. A computer-readable medium containing one or more instructions for execution by a computer to:
receive metadata over a network from providers;
receive a query over the network from a customer; and
search through the metadata to identify metadata that is relevant to the customer query.

24. The computer-readable medium of claim 23, further comprising instructions for execution by a computer to:
respond to the customer query by forwarding to the customer over the network the identity of one or more providers that provided metadata identified as relevant to the customer query.

25. The computer-readable medium of claim 23, further comprising instructions for execution by a computer to:
respond to the customer query by forwarding to the customer over the network metadata identified as relevant to the customer query.

26. The computer-readable medium of claim 23, further comprising instructions for execution by a computer to:
respond to the customer query by forwarding to the customer over the network one or more of metadata identified as relevant to the customer query and the identity of one or more providers that provided forwarded metadata.

27. The computer-readable medium of claim 26, wherein the identity of each provider that is forwarded to the customer is received from the respective provider.

28. The computer-readable medium of claim 23, further comprising instructions for execution by a computer to:
respond to the customer query by taking action on behalf of the customer.

29. The computer-readable medium of claim 28, wherein the action taken on behalf of the customer is defined by the customer.

30. The computer-readable medium of claim 23, further comprising instructions for execution by a computer to:
receive additional metadata after receiving the customer query and searching through the metadata; and
search through the additional metadata to identify additional metadata that is relevant to the customer query.

31. The computer-readable medium of claim 30, further comprising instructions for execution by a computer to:
after identifying additional metadata that is relevant to the customer query, respond to the customer query by taking action on behalf of the customer.

32. The computer-readable medium of claim 31, wherein the action taken on behalf of the customer is defined by the customer.

33. The computer-readable medium of claim 30, further comprising instructions for execution by a computer to:
after identifying additional metadata that is relevant to the customer query, respond to the customer query by forwarding to the customer over the network either one or both of the additional metadata identified as relevant to the customer query and the identity of the provider that provided each additional metadata identified as relevant to the customer query.

34. The computer-readable medium of claim 23, wherein the metadata received from each provider describes any one or more of data, services, and/or goods available to the customer from the respective provider, data, services, and/or goods desired by the respective provider, and real-world events.

35. The computer-readable medium of claim 23, further comprising instructions for execution by a computer to:
receive an update to the customer query from the customer after searching through the metadata; and
search through the metadata to identify metadata that is relevant to the updated customer query.

36. The computer-readable medium of claim 23, further comprising instructions for execution by a computer to:
receive a plurality of customer queries over the network;
search through the metadata to identify metadata that is relevant to each of the plurality of received customer queries;
respond to each received customer query by forwarding to the respective customer over the network one or more of metadata identified as relevant to the query and the identity of one or more providers that provided relevant metadata;
receive additional metadata after responding to the plurality of received customer queries; and
search through the additional metadata to identify additional metadata that is relevant to each received customer query.

37. The computer-readable medium of claim 36, further comprising instructions for execution by a computer to:
after identifying additional metadata that is relevant to one or more of the received customer queries, respond to one or more of the received customer queries by forwarding to each respective customer over the network either one or both of additional metadata identified as relevant to the particular customer query and the identity of one or more providers that provided relevant metadata.

38. The computer-readable medium of claim 36, further comprising instructions for execution by a computer to:
after identifying additional metadata that is relevant to each received customer query, respond to one or more of the received customer queries by taking action on behalf of the respective customer.

39. The computer-readable medium of claim 36, further comprising instructions for execution by a computer to:
repeatedly receive additional metadata; and
search each received additional metadata to identify metadata relevant to any of the received customer queries.

40. The computer-readable medium of claim 30, wherein received additional metadata is searched to identify metadata relevant to the customer query until a time period expires.

41. The computer-readable medium of claim 40, wherein the time period is specified by the customer.

42. The computer-readable medium of claim 23, wherein the instructions for execution by a computer to receive metadata over a network from providers comprise instructions for execution by the computer to receive metadata at the initiation of each respective metadata provider.

43. An apparatus, comprising:
a metadata store for receiving metadata;
a communications module for receiving a query; and
a search engine for searching through the received metadata to identify metadata that is relevant to the query.

44. The apparatus of claim 43, wherein:
the metadata store is for receiving the metadata over a network from providers; and
the communications module is for receiving the query over the network from a customer.

45. The apparatus of claim 43, wherein the communications module is further for responding to the customer query by forwarding to the customer over the network the identity of one or more providers that provided metadata identified as relevant to the customer query.

46. The apparatus of claim 43, wherein the communications module is further for responding to the customer query by forwarding to the customer over the network metadata identified as relevant to the customer query.

47. The apparatus of claim 43, wherein the communications module is further for responding to the customer query by forwarding to the customer over the network one or more of metadata identified as relevant to the customer query and the identity of one or more providers that provided forwarded metadata.

48. The apparatus of claim 46, wherein the identity of each provider that is forwarded to the customer is received from the respective provider.

49. The apparatus of claim 43, wherein the communications module is further for responding to the customer query by taking action on behalf of the customer.

50. The apparatus of claim 49, wherein the action taken on behalf of the customer is defined by the customer.

51. The apparatus of claim 43, wherein the metadata store is further for receiving additional metadata after receiving the customer query and searching through the metadata; and
the search engine is further for searching through the additional metadata to identify additional metadata that is relevant to the customer query.

52. The apparatus of claim 51, wherein the communications module is further for, after additional metadata that is relevant to the customer query has been identified, responding to the customer query by taking action on behalf of the customer.

53. The apparatus of claim 52, wherein the action taken on behalf of the customer is defined by the customer.

54. The apparatus of claim 51, wherein the communications module is further for, after additional metadata that is relevant to the customer query has been identified, responding to the customer query by forwarding to the customer over the network either one or both of the additional metadata identified as relevant to the customer query and the identity of the provider that provided each additional metadata identified as relevant to the customer query.

55. The apparatus of claim 43, wherein the metadata received from each provider describes any one or more of data, services, and/or goods available to the customer from the respective provider, data, services, and/or goods desired by the respective provider, and real-world events.

56. The apparatus of claim 43, wherein the metadata store is further for receiving an update to the customer query from the customer after searching through the metadata; and
the search engine is further for searching through the metadata to identify metadata that is relevant to the updated customer query.

57. The apparatus of claim 43, wherein the communications module is further for receiving a plurality of customer queries over the network;
the search engine is further for searching through the metadata to identify metadata that is relevant to each of the plurality of received customer queries;
the communications module is further for responding to each received customer query by forwarding to the respective customer over the network one or more of metadata identified as relevant to the query and the identity of one or more providers that provided relevant metadata;
the communications module is further for receiving additional metadata after responding to the plurality of received customer queries; and
the search engine is further for searching through the additional metadata to identify additional metadata that is relevant to each received customer query.

58. The apparatus of claim 57, wherein the communications module is further for, after additional metadata that is relevant to one or more of the received customer queries has been identified, responding to one or more of the received customer queries by forwarding to each respective customer over the network either one or both of additional metadata identified as relevant to the particular customer query and the identity of one or more providers that provided relevant metadata.

59. The apparatus of claim 57, wherein the communications module is further for, after additional metadata that is relevant to each received customer query has been identified, responding to one or more of the received customer queries by taking action on behalf of the respective customer.

60. The apparatus of claim 57, wherein the metadata store is further for repeatedly receiving additional metadata; and
the search engine is further for searching each received additional metadata to identify metadata relevant to any of the received customer queries.

61. The apparatus of claim 51, wherein received additional metadata is searched to identify metadata relevant to the customer query until a time period expires.

62. The apparatus of claim 61, wherein the time period is specified by the customer.

63. The apparatus of claim 43, wherein the metadata store is for receiving metadata at the initiation of each respective metadata provider.
